(19) United States
(12) Patent Application Publication
(10) Pub. No.: US 2012/0007276 A1
(43) Pub. Date: Jan. 12, 2012

(54) IMPRINT TEMPLATE, METHOD FOR MANUFACTURING IMPRINT TEMPLATE, AND PATTERN FORMATION METHOD

(76) Inventors: Katsutoshi KOBAYASHI, Tokyo (JP); Yoshihisa Kawamura, Kanagawa-ken (JP); Shinichi Ito, Kanagawa-ken (JP)

(21) Appl. No.: 13/168,570

(22) Filed: Jun. 24, 2011

(30) Foreign Application Priority Data
Jul. 7, 2010 (JP) 2010-154660

(51) Int. Cl. B29C 33/42; B29C 59/02

(52) U.S. Cl. 264/224; 425/385; 264/293

(57) ABSTRACT

According to one embodiment, an imprint template includes a base substrate and a resin-based pattern transfer portion. The pattern transfer portion is formed on a major surface of the base substrate and includes a protrusion-depression pattern. A shape of the protrusion-depression pattern is transferred to a transfer target. The protrusion-depression portion is provided at the major surface of the base substrate. A major surface side of the pattern transfer portion is provided so as to fit into a depression of the protrusion-depression portion. In another embodiment, a pattern formation method is disclosed. The method can include providing the transfer target on the substrate, and using the imprint template to bring the pattern into contact with the transfer target. In addition, the method can include curing the transfer target and then releasing the imprint template from the transfer target to transfer the shape of the pattern to the transfer target.

### CROSS-REFERENCE TO RELATED APPLICATIONS

This application is based upon and claims the benefit of priority from the prior Japanese Patent Application No. 2010-154660, filed on Jul. 7, 2010; the entire contents of which are incorporated herein by reference.

### FIELD

Embodiments described herein relate generally to an imprint template, a method for manufacturing the imprint template, and a pattern formation method.

### BACKGROUND

In manufacturing of semiconductor devices and MEMS (microelectromechanical system) devices, the nanoimprint method for transferring the pattern of an original plate to a transfer target substrate has been drawing attention as a technology for achieving compatibility between fine pattern formation and volume productivity.

In the nanoimprint method, droplets of photocurable resin are placed on a substrate. A quartz template is brought into contact with this substrate. Then, with the photocurable resin filled in the recessed pattern of the quartz template, the photocurable resin is irradiated with ultraviolet light through the quartz template. Thus, the resin is cured. Subsequently, the quartz template is released from the substrate. Thus, a resin pattern is formed on the substrate.

To use the nanoimprint method in processing a processing target film such as a semiconductor layer or insulating film, the aforementioned resin pattern is formed on the processing target film. Then, this resin pattern is used as a mask to process the processing target film by etching such as RIE (reactive ion etching).

However, repetition of the imprint process causes degradation and breakage in the template. Thus, regularly or each time, it is necessary to remake a new template. This results in increasing the manufacturing cost of semiconductor devices.

### BRIEF DESCRIPTION OF THE DRAWINGS

FIG. 1 is a schematic sectional view illustrating the configuration of an imprint template according to a first embodiment;

FIGS. 2A and 2B are schematic sectional views illustrating a first example shape of the major surface;

FIGS. 3A and 3B are schematic sectional views illustrating a second example shape of the major surface;

FIGS. 4A to 4C are schematic enlarged sectional views illustrating other example shapes of the major surface;

FIGS. 5A to 6B are schematic sectional views sequentially illustrating a method for manufacturing an imprint template; and

FIGS. 7A to 11C are schematic sectional views sequentially showing an example of a pattern formation method according to the embodiment.

### DETAILED DESCRIPTION

In general, according to one embodiment, an imprint template includes a base substrate and a resin-based pattern transfer portion. The resin-based pattern transfer portion is formed on a major surface of the base substrate and includes a protrusion-depression pattern. A shape of the protrusion-depression pattern is transferred to a transfer target. The protrusion-depression portion is provided at the major surface of the base substrate. A side of the major surface of the pattern transfer portion is provided so as to fit into a depression of the protrusion-depression portion. In general, according to another embodiment, a method is disclosed for manufacturing an imprint template. The method can include applying a resin onto a protrusion-depression portion provided at a major surface of a base substrate. The method can include curing the resin while an original plate including a master pattern is brought into contact with the resin, the master pattern having a protrusion-depression shape being same as a protrusion-depression shape of a shaping target pattern. In addition, the method can include releasing the original plate from the resin to provide a pattern transfer portion having an inverted protrusion-depression pattern with respect to the shaping target pattern on the major surface of the base substrate.

In general, according to still another embodiment, a method is disclosed for manufacturing an imprint template. The method can include removing a pattern transfer portion formed on a major surface of a base substrate from the major surface of the base substrate. The method can include applying a resin onto the major surface of the base substrate from which the pattern transfer portion has been removed. The method can include curing the resin while an original plate including a master pattern is brought into contact with the resin, the master pattern having a protrusion-depression shape being same as a protrusion-depression shape of a shaping target pattern. In addition, the method can include releasing the original plate from the resin to provide a new pattern transfer portion having an inverted protrusion-depression pattern with respect to the shaping target pattern on the major surface of the base substrate.

In general, according to still another embodiment, a pattern formation method is disclosed. The method can include providing a transfer target on a substrate. The method can include using an imprint template with a resin-based pattern transfer portion formed on a base substrate to bring a protrusion-depression pattern of the pattern transfer portion into contact with the transfer target. In addition, the method can include curing the transfer target and then releasing the imprint template from the transfer target to transfer a shape of the protrusion-depression pattern to the transfer target.

Various embodiments will be described hereinafter with reference to the accompanying drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In the present specification and the drawings, components similar to those described previously with reference to earlier figures are labeled with like reference numerals, and the detailed description thereof is omitted as appropriate.

### First Embodiment

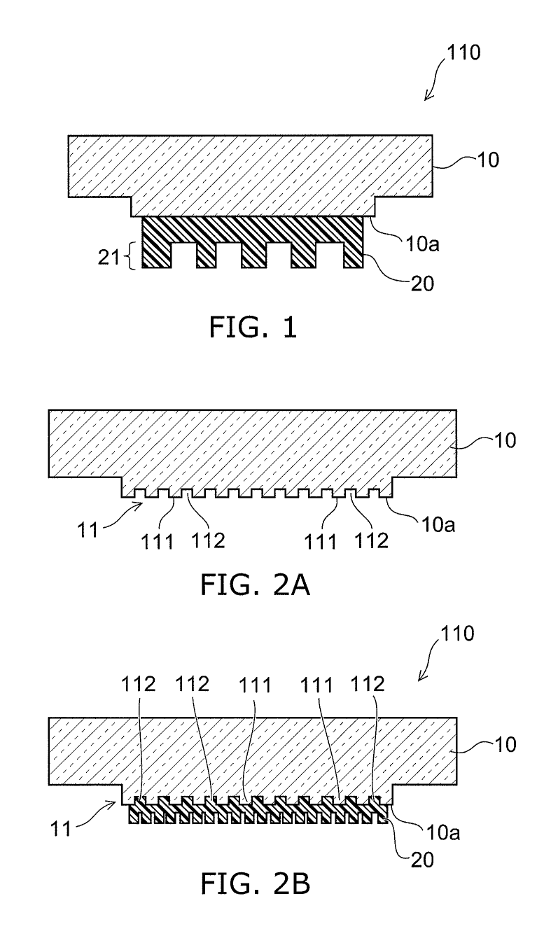

FIG. 1 is a schematic sectional view illustrating the configuration of an imprint template according to a first embodiment.

As shown in FIG. 1, the imprint template 110 according to the embodiment includes a base substrate 10 and a resin-based pattern transfer portion 20 formed on the base substrate 10. The pattern transfer portion 20 includes a protrusion-depression pattern 21 for transferring a shape to a transfer target.

The base substrate 10 primarily serves to support the pattern transfer portion 20. The base substrate 10 is made of a material capable of supporting the pattern transfer portion 20, resistant to application of a prescribed pressure, and suitable for an imprint process. Examples of such a material include a glass material such as quartz glass, a metal material, and a resin material. For instance, in the case of performing an imprint process using such light as ultraviolet radiation, the base substrate 10 is made of a material (e.g., quartz glass and resin material) sufficiently transparent to the light of a prescribed wavelength such as ultraviolet radiation. In the case of performing an imprint process based on application of heat and pressure, the base substrate 10 is made of a material (e.g., metal material and resin material) sufficiently resistant to application of heat and pressure.

The resin-based pattern transfer portion 20 is formed on a major surface 10a of the base substrate 10. The major surface 10a is configured so that the resin-based pattern transfer portion 20 can adhere thereto. That is, in the imprint template 110, the pattern transfer portion 20 is brought into contact with a transfer target to transfer the shape of the protrusion-depression pattern 21 to the transfer target. After the transfer, the imprint template 110 is released. At this time, it is necessary to prevent peeling of the pattern transfer portion 20 formed on the major surface 10a of the base substrate 10. The adhesive strength between the major surface 10a and the pattern transfer portion 20 is set so that the pattern transfer portion 20 is not peeled when the imprint template 110 is released from the transfer target.

The pattern transfer portion 20 can be based on various resin materials such as thermosetting resin, thermoplastic resin, and photocurable resin. A protrusion-depression pattern 21 is provided at the surface of the pattern transfer portion 20 opposite to the major surface 10a. The material of the pattern transfer portion 20 is selected in consideration of the moldability of the protrusion-depression pattern 21 and the imprint process.

The protrusion-depression pattern 21 is formed by the original plate described later. This original plate is provided with a master pattern. The master pattern has the same protrusion-depression shape as the shaping target pattern to be shaped by imprinting. In the protrusion-depression pattern 21, the protrusion-depression shape of the master pattern has been transferred. That is, the protrusion-depression pattern 21 has an inverted protrusion-depression shape with respect to the shaping target pattern.

The resin-based pattern transfer portion 20 can be reproduced on the base substrate 10 by transferring the master pattern of the original plate. Here, the width of the depression, or the width of the protrusion, of the protrusion-depression pattern 21 is e.g. several ten to several hundred nm (nanometers). Imprinting using the protrusion-depression pattern 21 at the nanometer level is called nanoimprinting. The shape of the protrusion-depression pattern 21 is arbitrary, such as a line shape extending in one direction, a rectangular shape, and a curved shape.

In pattern formation using the imprint template 110 like this, the pattern transfer portion 20 of the imprint template 110 is brought into contact with a transfer target to transfer the protrusion-depression shape of the protrusion-depression pattern 21. After transferring the protrusion-depression shape of the protrusion-depression pattern 21 to the transfer target, the imprint template 110 is released from the transfer target.

Here, in consideration of releasability of the imprint template 110 from the transfer target, a release agent may be provided on the surface of the protrusion-depression pattern 21. Alternatively, releasability may be imparted to the resin itself constituting the protrusion-depression pattern 21.

In the imprint template 110 according to the embodiment, the resin-based pattern transfer portion 20 is formed on the base substrate 10. Hence, the pattern transfer portion 20 can be easily reproduced. In imprinting, repetition of the transfer process causes degradation and breakage, such as deformation of the protrusion-depression pattern 21 of the pattern transfer portion 20. In the imprint template 110 according to the embodiment, in the case of such degradation and breakage, only the pattern transfer portion 20 is removed from the base substrate 10, and a new pattern transfer portion 20 is only reproduced on the same base substrate 10. By repetitively using the base substrate 10, the imprint template 110 is reproduced at low cost. Furthermore, the original plate is used only in producing (reproducing) the pattern transfer portion 20. Hence, the frequency of using the original plate is reduced.

FIGS. 2A to 4C are schematic sectional views illustrating example shapes of the major surface 10a of the base substrate 10 of the imprint template 110.

FIGS. 2A and 2B are schematic sectional views illustrating a first example shape of the major surface.

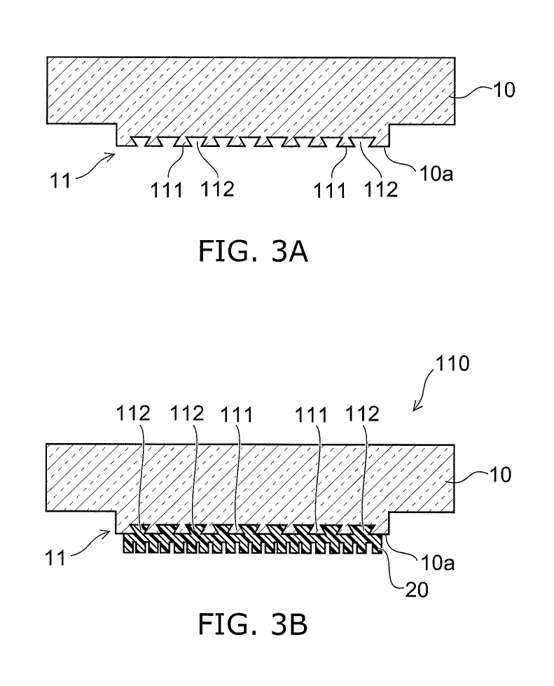

FIGS. 3A and 3B are schematic sectional views illustrating a second example shape of the major surface.

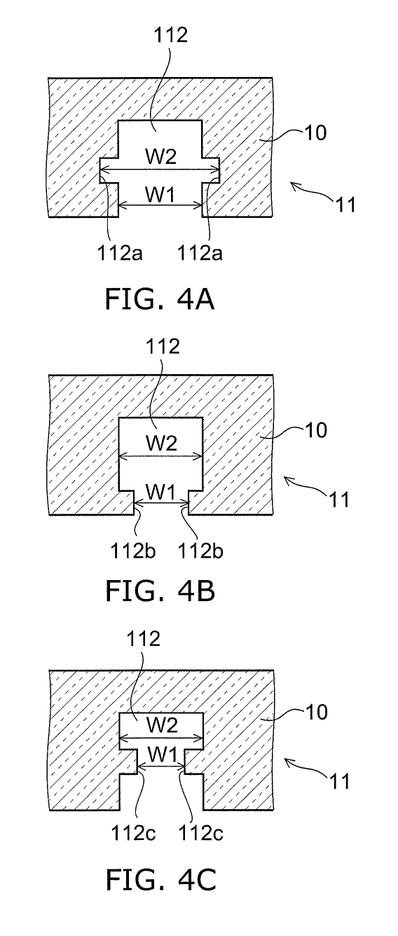

FIGS. 4A to 4C are schematic enlarged sectional views illustrating other example shapes of the major surface.

The example shapes of the major surface 10a of the base substrate 10 illustrated in FIGS. 2A to 4C are all examples of increasing the adhesive strength of the pattern transfer portion 20.

FIGS. 2A and 2B illustrate one example shape of the major surface 10a of the base substrate 10.

As shown in FIG. 2A, a protrusion-depression portion 11 is provided at the major surface 10a of this base substrate 10. A depression 112 or a protrusion 111 in the protrusion-depression portion 11 is provided arbitrarily along the major surface 10a, such as in a line shape, a rectangular shape, and a curved shape. The protrusion-depression portion 11 provided at the major surface 10a increases the surface area of the major surface 10a as compared with the case where the major surface 10a is planar. The increase of the surface area of the major surface 10a results in increasing the area of contact with the pattern transfer portion 20. This improves the adhesive strength of the pattern transfer portion 20.

As shown in FIG. 2B, the pattern transfer portion 20 is formed on the major surface 10a of the base substrate 10. The pattern transfer portion 20 is provided so as to fit into the depressions 112 of the protrusion-depression portion 11 provided at the major surface 10a. Thus, the pattern transfer portion 20 is formed on the major surface 10a including the protrusion-depression portion 11. This can increase the adhesive strength of the pattern transfer portion 20 as compared with the case where the major surface 10a is planar.

The protrusion-depression portion 11 of the major surface 10a may be provided either entirely or partly at the major surface 10a. The size of the protrusion-depression portion 11 can be suitably adjusted. In the major surface 10a, the position and region to be provided with the protrusion-depression portion 11 and the size of the protrusion-depression portion 11 can be adjusted to suitably set the adhesive strength of the pattern transfer portion 20.

FIGS. 3A and 3B illustrate another example shape of the major surface 10a of the base substrate 10.

In the base substrate 10 shown in FIG. 3A, a protrusion-depression portion 11 is provided at the major surface 10a. In this protrusion-depression portion 11, the protrusion 111 is widened from root to tip (formed in a reverse tapered shape). The protrusion 111 is provided arbitrarily along the major surface 10a, such as in a line shape, a rectangular shape, and a curved shape. The protrusions and depressions provided at the major surface 10a increase the surface area of the major surface 10a as compared with the case where the major surface 10a is planar. The increase of the surface area of the major surface 10a results in increasing the area of contact with the pattern transfer portion 20. This improves the adhesive strength of the pattern transfer portion 20.

As shown in FIG. 3B, the pattern transfer portion 20 is formed on the major surface 10a of the base substrate 10. The pattern transfer portion 20 is provided so as to fit into the depressions 112 of the protrusion-depression portion 11 provided at the major surface 10a. The protrusion 111 shown in FIGS. 3A and 3B is formed in a reverse tapered shape. Thus, the pattern transfer portion 20 fits into the depressions 112 to achieve an anchor effect. This can increase the adhesive strength of the pattern transfer portion 20 as compared with the case where the major surface 10a is planar.

The protrusion-depression portion 11 of the major surface 10a may be provided either entirely or partly at the major surface 10a. The size of the protrusion-depression portion 11 and the angle of the reverse taper of the protrusion 111 can be suitably adjusted. In the major surface 10a, the position and region to be provided with the protrusion-depression portion 11, the size of the protrusion-depression portion 11, and the angle of the reverse taper of the protrusion 111 can be adjusted to suitably set the adhesive strength of the pattern transfer portion 20.

FIGS. 4A to 4C illustrate example shapes of the depression of the protrusion-depression shape provided at the major surface 10a.

In FIGS. 4A to 4C, one of the depressions 112 provided at the major surface 10a is shown in an enlarged view. Actually, the major surface 10a is provided with one or more such depressions 112.

As shown in FIGS. 4A to 4C, in the depression 112 of the protrusion-depression portion 11 provided at the major surface 10a of the base substrate 10, the opening size W1 at a first depth is smaller than the opening size W2 at a second depth that is closer to the bottom than the first depth. This can achieve an anchor effect in the formation of the pattern transfer portion 20 on the major surface 10a.

In the depression 112 shown in FIG. 4A, a recess 112a is provided between the opening end and the bottom. The recess 112a illustrated in FIG. 4A is rectangular in cross section. However, the recess 112a may be other than rectangular, such as triangular and semicircular. In the depression 112 shown in FIG. 4A, for instance, the opening size at the first depth is defined as the opening size W1a at the opening end. The opening size at the second depth is defined as the opening size W2a at the recess 112a. Then, the relation W1a<W2a holds.

In the depression 112 shown in FIG. 4B, a projection 112b is provided at the opening end. The projection 112b illustrated in FIG. 4B is rectangular in cross section. However, the projection 112b may be other than rectangular, such as triangular and semicircular. In the depression 112 shown in FIG. 4B, for instance, the opening size at the first depth is defined as the opening size W1b at the position of the projection 112b provided at the opening end. The opening size at the second depth is defined as the opening size W2b at the position closer to the bottom than the projection 112b. Then, the relation W1b<W2b holds.

In the depression 112 shown in FIG. 4C, a projection 112c is provided between the opening end and the bottom. The projection 112c illustrated in FIG. 4C is rectangular in cross section. However, the projection 112c may be other than rectangular, such as triangular and semicircular. In the depression 112 shown in FIG. 4C, for instance, the opening size at the first depth is defined as the opening size W1c at the position of the projection 112c. The opening size at the second depth is defined as the opening size W2c at the position closer to the bottom than the projection 112c. Then, the relation W1c<W2c holds.

In any of the depressions 112 shown in FIGS. 4A to 4C, the resin 2 of the pattern transfer portion 20 fits into the depressions 112 to achieve a robust anchor effect in the formation of the pattern transfer portion 20.

Here, the major surface 10a may be subjected to surface roughening in addition to the protrusion-depression portion 11 of the major surface 10a, the reverse tapered shape of the protrusion 111, and various shapes of the depression 112 described above. Furthermore, surface roughening may be applied to the surface of the protrusion 111 and the surface of the depression 112 of the protrusion-depression portion 11 provided at the major surface 10a. Surface roughening increases the surface area. The increase of the contact area of the pattern transfer portion 20 improves the adhesive strength.

### Second Embodiment

Next, a method for manufacturing an imprint template according to a second embodiment is described.

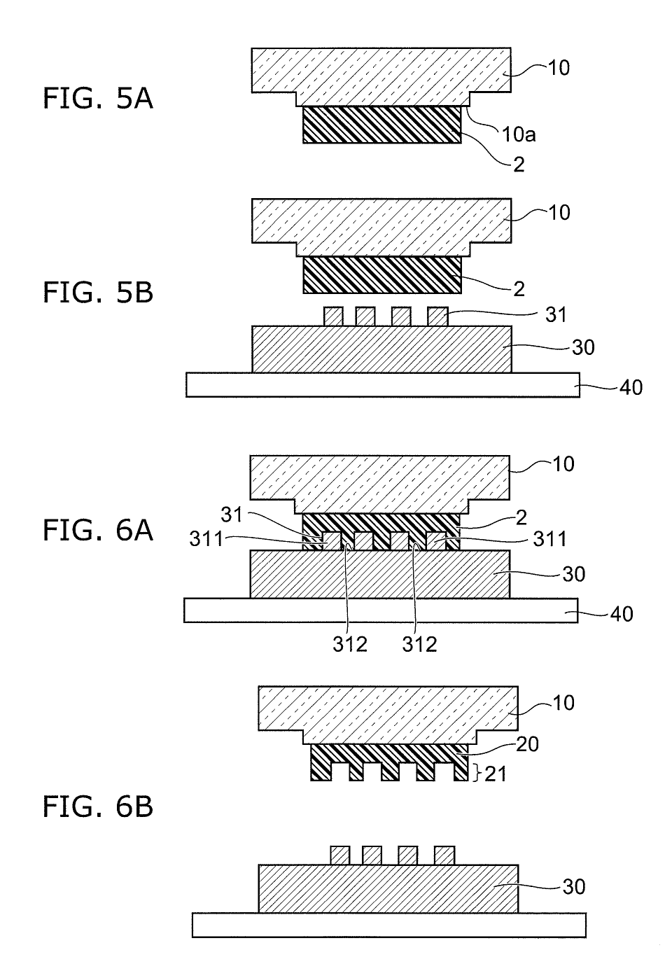

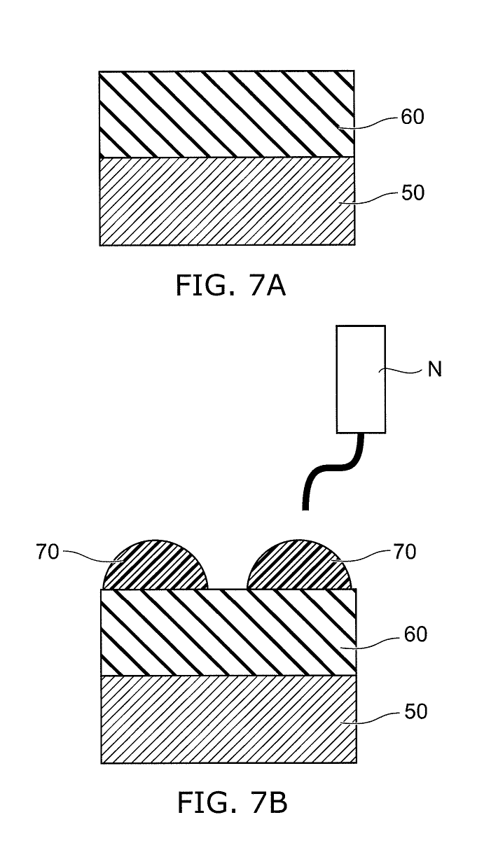

FIGS. 5A to 6B are schematic sectional views sequentially illustrating the method for manufacturing an imprint template.

The method for manufacturing an imprint template according to the embodiment includes the process of applying a resin 2 onto the major surface 10a of a base substrate 10, the process of curing the resin 2 while an original plate 30 including a master pattern 31 having the same protrusion-depression shape as a shaping target pattern is brought into contact with the resin 2, and the process of releasing the original plate 30 from the resin 2 to provide a pattern transfer portion 20 having an inverted protrusion-depression pattern 21 with respect to the shaping target pattern on the major surface 10a of the base substrate 10.

First, as shown in FIG. 5A, the resin 2 is applied onto the major surface 10a of the base substrate 10. The resin 2 is one of a thermosetting resin, thermoplastic resin, and photocurable resin. In the embodiment, as an example, a thermosetting resin is used. The resin 2 is applied uniformly, for instance, onto the major surface 10a of the base substrate 10. The resin 2 is applied uniformly onto the major surface 10a by e.g. spin coating. Alternatively, the protrusion-depression portion 11 described above may be provided at the major surface 10a of the base substrate 10, and the resin 2 may be applied onto this protrusion-depression portion 11.

Next, as shown in FIG. 5B, the original plate 30 is prepared. The original plate 30 is provided with the master pattern 31 having the same protrusion-depression shape as the shaping target pattern. The original plate 30 is made of e.g. metal or silicon. The same protrusion-depression shape as the shaping target pattern is processed at the surface of a metal or silicon substrate to provide the master pattern 31. Alternatively, the same protrusion-depression shape as the shaping target pattern may be processed in a coating provided on the surface of a metal or silicon substrate to provide the master pattern 31.

The original plate 30 like this is mounted on a hot plate 40. The master pattern 31 of the original plate 30 is opposed to the resin 2 on the base substrate 10.

Next, as shown in FIG. 6A, the resin 2 on the base substrate 10 is brought into contact with the master pattern 31 of the original plate 30. Thus, protrusions 311 of the master pattern 31 are pressed into the resin 2, and the resin 2 fits into depressions 312. In this state, the original plate 30 is heated by the hot plate 40. The resin 2 is heated by heat transferred from the original plate 30 to the resin 2. The thermosetting resin 2 is cured when heated to above a prescribed temperature.

In the case where the resin 2 is a thermoplastic resin, the resin 2 on the base substrate 10 is brought into contact with the master pattern 31 of the original plate 30. In this state, the resin 2 is heated by the hot plate 40 to a temperature above the glass transition point. With the protrusion-depression shape of the master pattern 31 transferred to the resin 2, the resin 2 is cooled (heating is stopped) and cured.

In the case where the resin 2 is a photocurable resin, the resin 2 on the base substrate 10 is brought into contact with the master pattern 31 of the original plate 30. With the protrusion-depression shape of the master pattern 31 transferred to the resin 2, the resin 2 is irradiated with prescribed light (e.g., ultraviolet light). Thus, the resin 2 is cured.

After the resin 2 is cured, as shown in FIG. 6B, the base substrate 10 is released from the original plate 30. Thus, the pattern transfer portion 20 having the protrusion-depression pattern 21 is formed on the major surface 10a of the base substrate 10. The protrusion-depression pattern 21 has an inverted protrusion-depression shape with respect to the master pattern 31.

Here, the adhesive strength between the base substrate 10 and the resin 2 (pattern transfer portion 20) is stronger than the adhesive strength between the original plate 30 and the resin 2 (pattern transfer portion 20). Hence, the base substrate 10 can be released from the original plate 30 without peeling of the pattern transfer portion 20 from the base substrate 10.

To increase the adhesive strength between the base substrate 10 and the pattern transfer portion 20, as shown in FIGS. 2A and 2B, the protrusion-depression portion 11 can be provided at the major surface 10a of the base substrate 10. Alternatively, as shown in FIGS. 3A and 3B, the protrusion 111 of the major surface 10a can be formed in a reverse tapered shape. Further alternatively, the depression 112 of the major surface 10a can be shaped as shown in FIGS. 4A to 4C. Further alternatively, the major surface 10a can be roughened.

By releasing from the original plate 30, the imprint template 110 with the pattern transfer portion 20 formed on the major surface 10a of the base substrate 10 is completed. By the method for manufacturing the imprint template 110 like this, the pattern transfer portion 20 having the resin-based protrusion-depression pattern 21 transferred from the master pattern 31 of the original plate 30 can be formed on the major surface 10a of the base substrate 10.

Here, repetition of imprinting using the imprint template 110 causes degradation and breakage in the pattern transfer portion 20. In this case, the pattern transfer portion 20 is removed from the base substrate 10. To remove the pattern transfer portion 20 from the base substrate 10, for instance, the pattern transfer portion 20 is irradiated with ultraviolet radiation on the major surface 10a side to decompose the resin at the contact portion with the major surface 10a by ozone. Alternatively, the pattern transfer portion 20 is dissolved with a solvent. Examples of the solvent (cleaning liquid) include a mixture of H₂SO₄ (sulfuric acid) and H₂O₂ (hydrogen peroxide), a mixture of NH₄OH (ammonium hydroxide), H₂O₂, and H₂O, and a mixture of choline and H₂O. Thus, the pattern transfer portion 20 is removed from the major surface 10a of the base substrate 10.

Then, by reusing the base substrate 10 after removing of the pattern transfer portion 20, a new pattern transfer portion 20 is formed on the major surface 10a of the base substrate 10 by the process shown in FIGS. 5A to 6B. The original plate 30 is used only in forming the pattern transfer portion 20. The base substrate 10 is repetitively used. Thus, even if the pattern transfer portion 20 is degraded, the imprint template 110 can be reproduced at low cost.

In the example shown in the above embodiment, the resin 2 is a thermosetting resin. In the case of using a thermoplastic resin, as shown in FIG. 6A, the resin 2 is brought into contact with the original plate 30. In this state, the resin 2 is heated to transfer the master pattern 31 of the original plate 30 to the resin 2. Subsequently, the temperature of the resin 2 is lowered to cure the resin 2. Thus, the protrusion-depression pattern 21 of the pattern transfer portion 20 is molded.

In the case where the resin 2 is a photocurable resin, as shown in FIG. 6A, the resin 2 is brought into contact with the original plate 30. In this state, the resin 2 is irradiated with ultraviolet radiation through the base substrate 10. After the resin 2 is cured by ultraviolet radiation, the base substrate 10 is released from the original plate 30. Thus, the protrusion-depression pattern 21 of the pattern transfer portion 20 transferred from the master pattern 31 is formed.

### Third Embodiment

Next, an example of a pattern formation method according to a third embodiment is described.

FIGS. 7A to 11C are schematic sectional views sequentially showing an example of the pattern formation method according to the embodiment.

The pattern formation method according to the embodiment includes the process of providing a transfer target on a substrate, the process of using an imprint template 110 with a resin-based pattern transfer portion 20 formed on a base substrate 10 to bring a protrusion-depression pattern 21 of the pattern transfer portion 20 into contact with the transfer target, the process of curing the transfer target and then releasing the imprint template 110 from the transfer target to transfer the shape of the protrusion-depression pattern 21 to the transfer target.

First, as shown in FIG. 7A, a shaping target 60 is provided on a substrate 50. The substrate 50 is made of e.g. silicon. The shaping target 60 is made of e.g. silicon oxide. In this example, as an example of the shaping target 60, silicon oxide is formed to a thickness of 2000 angstroms on the silicon substrate 50.

Next, as shown in FIG. 7B, a transfer target 70 is provided on the shaping target 60. The transfer target 70 is made of e.g. a thermosetting resin or photocurable resin. This example is described for the case of using a photocurable resin. For instance, the transfer target 70 is dropped onto the shaping target 60 from a nozzle N by the ink jet method. Alternatively, the transfer target 70 may be uniformly provided by e.g. spin coating.

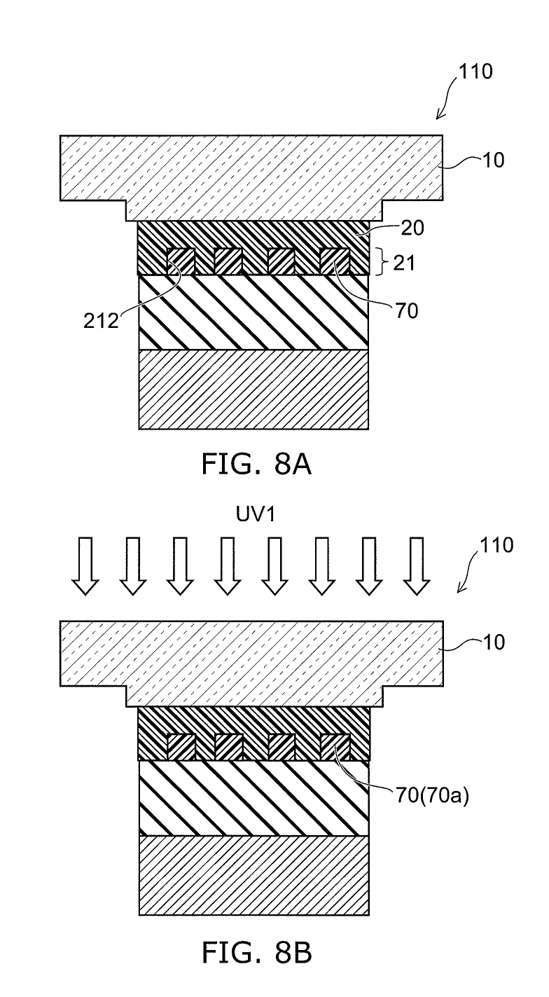

Next, as shown in FIG. 8A, the pattern transfer portion 20 of the imprint template 110 is brought into contact with the transfer target 70. By capillarity, the transfer target 70 penetrates into depressions 212 of the protrusion-depression pattern 21 of the pattern transfer portion 20 and is filled in the depressions 212.

Next, as shown in FIG. 8B, with the pattern transfer portion 20 of the imprint template 110 brought into contact with the transfer target 70, ultraviolet radiation UV1 is applied from the base substrate 10 side of the imprint template 110. The ultraviolet radiation UV1 is transmitted through the base substrate 10 and the pattern transfer portion 20 and applied to the transfer target 70. The transfer target 70 made of the photocurable resin is cured by irradiation with the ultraviolet radiation UV1. The wavelength of the ultraviolet radiation UV1 is e.g. approximately 300-400 nm. Here, the base substrate 10 and the pattern transfer portion 20 are made of materials sufficiently translucent to the ultraviolet radiation UV1. The transfer target 70 is cured into a transfer pattern 70a having an inverted protrusion-depression shape with respect to the protrusion-depression pattern 21 of the pattern transfer portion 20.

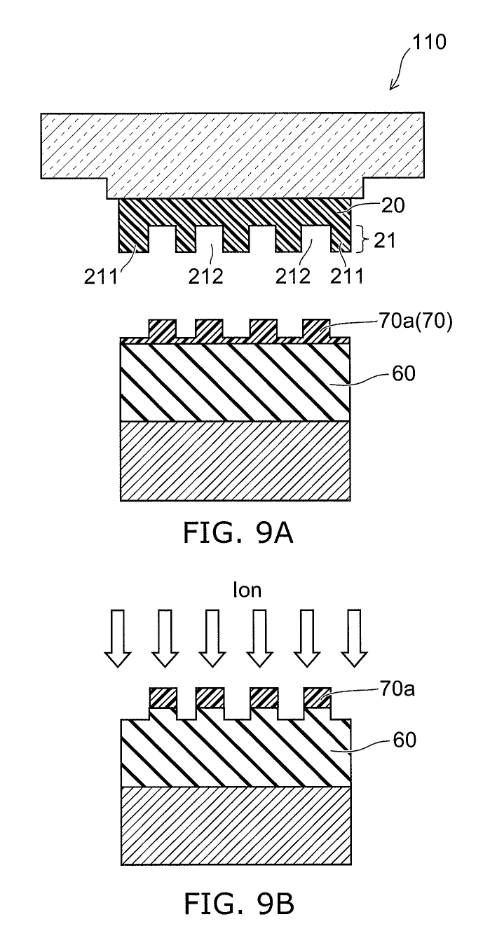

Next, as shown in FIG. 9A, the imprint template 110 is released from the transfer pattern 70a. Here, the adhesive strength between the base substrate 10 and the resin 2 (pattern transfer portion 20) is stronger than the adhesive strength between the transfer pattern 70a and the pattern transfer portion 20. Hence, the imprint template 110 can be released from the transfer pattern 70a without peeling of the pattern transfer portion 20 from the base substrate 10.

To increase the adhesive strength between the base substrate 10 and the pattern transfer portion 20, as shown in FIGS. 2A and 2B, the protrusion-depression portion 11 can be provided at the major surface 10a of the base substrate 10. Alternatively, as shown in FIGS. 3A and 3B, the protrusion 111 of the major surface 10a can be formed in a reverse tapered shape. Further alternatively, the depression 112 of the major surface 10a can be shaped as shown in FIGS. 4A to 4C. Further alternatively, the surface of the major surface 10a, the protrusion 111, and the depression 112 can be roughened.

Here, when the imprint template 110 is brought into contact with the transfer target 70, a protrusion 211 of the pattern transfer portion 20 may fail to be in complete contact with the surface of the shaping target 60. In this case, the transfer target 70 is interposed between the protrusion 211 of the pattern transfer portion 20 and the surface of the shaping target 60, and left at the bottom of the depression of the transfer pattern 70a after the imprint template 110 is released.

Next, as shown in FIG. 9B, the transfer pattern 70a formed on the shaping target 60 is used as a mask to etch the shaping target 60 by e.g. anisotropic RIE (reactive ion etching). After the etching, the transfer pattern 70a is removed. Thus, a pattern corresponding to the transfer pattern 70a is formed on the shaping target 60.

In imprinting, the processes shown in FIGS. 7A to 9B are repeated to transfer the protrusion-depression pattern 21 of the imprint template 110 to transfer targets 70. Thus, the same pattern can be formed in shaping targets 60.

Here, repetition of imprinting by a prescribed number of times causes degradation and breakage in the protrusion-depression pattern 21 of the pattern transfer portion 20. In this case, in the imprint template 110, only the pattern transfer portion 20 is reproduced. That is, if the original plate is used for imprinting, the original plate itself needs to be reproduced in the case of its degradation or breakage. However, in the imprint template 110 according to the embodiment, only the resin-based pattern transfer portion 20 is reproduced without remaking the original plate 30.

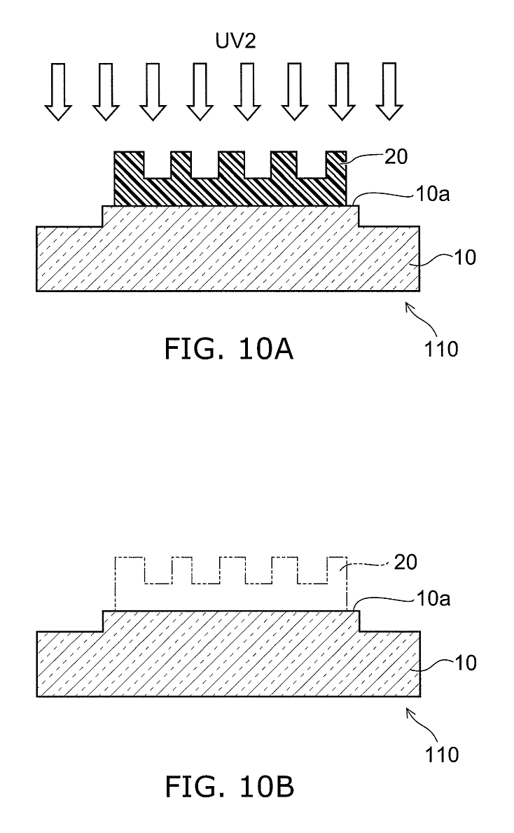

The pattern transfer portion 20 is reproduced as follows. First, as shown in FIG. 10A, the pattern transfer portion 20 of the imprint template 110 is removed from the base substrate 10. For instance, the imprint template 110 is irradiated with ultraviolet radiation UV2 to decompose the portion of the pattern transfer portion 20 in contact with the base substrate 10 by ozone. The wavelength of the ultraviolet radiation UV2 is e.g. 185 nm to generate ozone. Thus, as shown in FIG. 10B, the pattern transfer portion 20 is removed from the major surface 10a of the base substrate 10. Here, methods other than decomposition by ozone can also be used. For instance, a solvent for only the resin material of the pattern transfer portion 20 may be used to dissolve the pattern transfer portion 20.

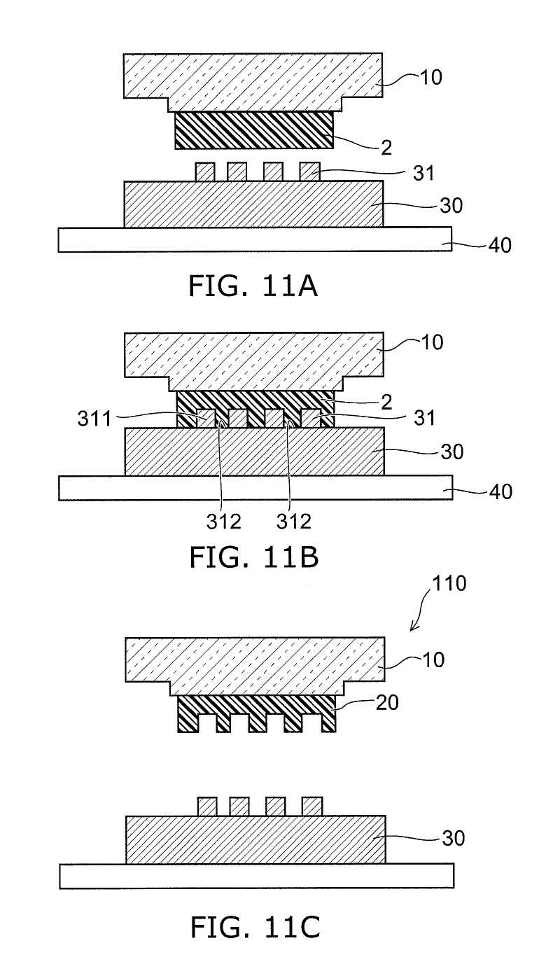

Next, the pattern transfer portion 20 is reproduced. The reproduction of the pattern transfer portion 20 reuses the base substrate 10 from which the pattern transfer portion 20 has been removed. First, as shown in FIG. 11A, the resin 2 is applied onto the major surface 10a of the base substrate 10 from which the pattern transfer portion 20 has been removed. Then, the master pattern 31 of the original plate 30 mounted on the hot plate 40 is opposed to the resin 2 on the base substrate 10.

Next, as shown in FIG. 11B, the resin 2 on the base substrate 10 is brought into contact with the master pattern 31 of the original plate 30. Thus, the protrusions 311 of the master pattern 31 are pressed into the resin 2, and the resin 2 fits into the depressions 312. In this state, the original plate 30 is heated by the hot plate 40. The resin 2 is heated by heat transferred from the original plate 30 to the resin 2. The thermosetting resin 2 is cured when heated to above a prescribed temperature.

After the resin 2 is cured, as shown in FIG. 11C, the base substrate 10 is released from the original plate 30. Thus, a new pattern transfer portion 20 is formed on the major surface 10a of the base substrate 10. The pattern transfer portion 20 includes a protrusion-depression pattern 21 having an inverted protrusion-depression shape with respect to the master pattern 31.

Thus, in the reproduction of the imprint template 110, the original base substrate 10 is reused. Furthermore, the original plate 30 is used only in producing (reproducing) the imprint template 110. Thus, even if the pattern transfer portion 20 is degraded, the imprint template 110 is reproduced at low cost without remaking the original plate 30.

After the imprint template 110 is reproduced, the imprint process shown in FIGS. 7A to 9B is performed to form a pattern. When the pattern transfer portion 20 is degraded due to repetition of imprinting, only the pattern transfer portion 20 can be reproduced as described above.

As described above, according to the embodiment, the frequency of using the original plate can be reduced. Furthermore, the base substrate 10 is reused. Hence, the imprint template 110 can be produced at low cost. Thus, semiconductor devices and MEMS devices can be manufactured by the imprint method at low cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An imprint template comprising:
a base substrate; and
a resin-based pattern transfer portion formed on a major surface of the base substrate and including a protrusion-depression pattern, a shape of the protrusion-depression pattern being transferred to a transfer target,
a protrusion-depression portion being provided at the major surface of the base substrate, and
a side of the major surface of the pattern transfer portion being provided so as to fit into a depression of the protrusion-depression portion.

2. The template according to claim 1, wherein opening size of the depression at a first depth is smaller than opening size at a second depth that is closer to bottom than the first depth.

3. The template according to claim 1, wherein a protrusion of the protrusion-depression portion is widened from root to tip.

4. The template according to claim 1, wherein the depression includes a recess between an opening end and a bottom of the depression.

5. The template according to claim 1, wherein the depression includes a projection at an opening end of the depression.

6. The template according to claim 1, wherein the depression includes a projection between an opening end and a bottom of the depression.

7. The template according to claim 1, wherein the pattern transfer portion is made of a thermosetting resin.

8. The template according to claim 1, wherein the pattern transfer portion is made of a thermoplastic resin.

9. The template according to claim 1, wherein the pattern transfer portion is made of a photocurable resin.

10. A method for manufacturing an imprint template, comprising:
applying a resin onto a protrusion-depression portion provided at a major surface of a base substrate;
curing the resin while an original plate including a master pattern is brought into contact with the resin, the master pattern having a protrusion-depression shape being same as a protrusion-depression shape of a shaping target pattern; and
releasing the original plate from the resin to provide a pattern transfer portion having an inverted protrusion-depression pattern with respect to the shaping target pattern on the major surface of the base substrate.

11. A method for manufacturing an imprint template, comprising:
removing a pattern transfer portion formed on a major surface of a base substrate from the major surface of the base substrate;
applying a resin onto the major surface of the base substrate from which the pattern transfer portion has been removed;
curing the resin while an original plate including a master pattern is brought into contact with the resin, the master pattern having a protrusion-depression shape being same as a protrusion-depression shape of a shaping target pattern; and
releasing the original plate from the resin to provide a new pattern transfer portion having an inverted protrusion-depression pattern with respect to the shaping target pattern on the major surface of the base substrate.

12. The method according to claim 11, wherein the removing the pattern transfer portion from the major surface of the base substrate includes irradiating the major surface of the base substrate with ultraviolet radiation to decompose the resin at a portion of the pattern transfer portion in contact with the base substrate by ozone.

13. The method according to claim 11, wherein the removing the pattern transfer portion from the major surface of the base substrate includes immersing the major surface of the base substrate in a cleaning liquid containing hydrogen peroxide to decompose the resin at a portion of the pattern transfer portion in contact with the base substrate by the hydrogen peroxide.

14. A pattern formation method comprising:
providing a transfer target on a substrate;
using an imprint template with a resin-based pattern transfer portion formed on a base substrate to bring a protrusion-depression pattern of the pattern transfer portion into contact with the transfer target; and
curing the transfer target and then releasing the imprint template from the transfer target to transfer a shape of the protrusion-depression pattern to the transfer target.

15. The method according to claim 14, wherein the providing the transfer target includes forming a shaping target on the substrate and providing the transfer target on the shaping target, the method further comprising:
etching the shaping target using as a mask the transfer target in which the shape of the protrusion-depression pattern is transferred.

16. The method according to claim 14, further comprising:
after the transferring the shape of the protrusion-depression pattern to the transfer target, removing the pattern transfer portion of the imprint template from the base substrate, and providing a new pattern transfer portion on the base substrate.

17. The method according to claim 16, wherein the pattern transfer portion is removed from the base substrate by irradiating the imprint template with ultraviolet radiation to decompose a portion of the pattern transfer portion in contact with the base substrate by ozone.

18. The method according to claim 16, wherein the pattern transfer portion is removed from the base substrate by using a solvent for a resin material of the pattern transfer portion to dissolve the pattern transfer portion.
